(19) United States
(12) Patent Application Publication
(10) Pub. No.: US 2016/0000117 A1
(43) Pub. Date: Jan. 7, 2016

(54) NATURAL AND SUSTAINABLE SEAWEED FORMULA THAT REPLACES SYNTHETIC ADDITIVES IN SWINE FEED

(71) Applicant: OCEAN HARVEST TECHNOLOGY (CANADA) INC., Vancouver (CA)

(72) Inventors: Stefan KRAAN, Headford, County Galway (IE); Patrick MARTIN, Milltown, Co Galway (IE); Colin MAIR, Lincolnshire (GB)

(21) Appl. No.: 14/770,788

(22) PCT Filed: Feb. 24, 2014
(86) PCT No.: PCT/CA2014/050127

§ 371 Date: Aug. 26, 2015

Related U.S. Application Data
(60) Provisional application No. 61/769,954, filed on Feb. 27, 2013.

(51) Int. Cl. A23K 1/14; A23K 1/18

(52) U.S. Cl. CPC A23K 1/14; A23K 1/184

(57) ABSTRACT

A seaweed-based commercial swine feed additive which replaces the synthetic chemical additives that are currently used in swine feed is provided. Synthetic additives are replaced with a combination of seaweed species thereby providing a natural product that improves the nutritional value of the pork, and may replace the chemical use of antibiotics.

### CROSS REFERENCE TO RELATED APPLICATION

The present application claims the benefits, under 35 U.S.C. §119(e), of U.S. Provisional Application Ser. No. 61/769,954 filed Feb. 27, 2013 entitled “Natural and Sustainable Seaweed Formula that Replaces Synthetic Additives In Swine Feed” which is incorporated herein by this reference.

### TECHNICAL FIELD

This invention relates to feed supplements for domestic animals and more particularly supplements containing seaweed for swine feed.

### BACKGROUND

Due to population increase and to increased meat consumption per capita, during the last 40 years, global pork production increased by a factor of 3.5. The main production areas for pork are East Asia, North America and Europe. Japan is a main importer of pork. The USA is changing from an importing country to a pork exporting country. The Western European market is characterized by change from a production oriented to market oriented. Other markets are also changing from production to market oriented, which means that production is becoming more consumer oriented, both in terms of the types of products and the method of production. Consumers expect attractive, nutritious and safe food from environmentally responsible and sustainable sources for a fair price. The keys for the successful future of pork production therefore are food safety, quality assurance and transparency, sustainability in production and a variety of products which are easy to prepare.

The continuous expansion of intensive pig farming of over 100 million tones of pork in 2009 (FAO, 2011) makes it a fast-growing sector of world food production. However, certain chemical additives and other key ingredients of diets of swine, along with a decline in availability and increasing costs has created a need for alternate sources for the swine industry. With the present trend to continue a need has arisen to use alternative and sustainable feed ingredients and antibiotic replacements. The recent food scares in the swine industry in 2008 (Ireland) and 2011 (Germany) showing pork with unacceptable high levels of PCB's and dioxins and other bio-accumulative contaminants, demanded further action to be taken to reduce contaminant levels in feed. Moreover, there has been a strongly growing demand for organic farmed products in many countries, insisting that pigs have to be organically fed and reared. The biochemical composition of marine macroalgae has received limited attention.

Intensive pig farming is susceptible to many diseases including: trichinosis, Taenia solium, cysticercosis, meningitis and brucellosis. Pigs are also known to be susceptible to parasitic ascarid worms. Antibiotics and other antimicrobials are currently routinely given to food animals in order to prevent disease, grow animals faster and to compensate for unsanitary conditions on many industrial farms. Bacteria exposed to antibiotics at low doses for prolonged periods can develop antibiotic-resistance. Since many of the classes of antibiotics used in food animal production also are important in human medicine, resistance that begins on the farm can lead to a serious public health problem. For example a new strain of methicillin-resistant Staphylococcus aureus, referred to as clonal complex (CC)398 has been identified in pigs (as well as other livestock) and people in Western European countries, North America, China and Singapore. There is a need therefore to reduce the use of antibiotics in swine feed.

It has been known to include seaweed supplement in the diet of mammals and poultry to enhance immune response and also to impart resistance to certain diseases in pigs. See U.S. Pat. No. 6,764,691. The inventors have determined a need for improved feed formulations swine which at least partially replace the anti-biotic additives that are currently used in swine feed.

The invention therefore provides a seaweed-based commercial swine feed additive which at least partially replaces the antibiotic additives that are currently used in swine feed. The invention replaces the synthetic additives with a sustainable natural product solely based on bioactives present in a variety of macroalgae (seaweed) that improves the nutritional value of the pork, and may replace the chemical use of antibiotics.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

### Manufacturing Process

Formulations according to some example embodiments of the invention may be made by combining certain specific species of seaweed in various proportions as described below. The seaweeds are typically combined by drying them and then crushing the dried seaweeds into a powder which can be relatively easily blended. The dried seaweeds may also be combined with other ingredients, as discussed below, to form the swine feed additive (“the Additive”).

The Additive preferably contains approximately 25-70% (by weight) of Ulva Lactuca (“Ulva”), about 5-25% (by weight) of Sargassum, about 2-15% (by weight) of Ascophyllum nodosum (“Asco”), about 2-15% (by weight) of Fucus vesiculosis (“Fucus”), about 2-30% (by weight) of Gracilaria, about 0.5-10% (by weight) of Palmaria palmata, about 0.5-10% (by weight) of Ascophyllum nodosum high fucose extract powder, and about 0.1-5% (by weight), of a mixture of one or more of the following: Plocamium cartilagineum, Polysiphonia, Falkenbergia, Delleseria and Osmundia.

The Additive more preferably contains approximately 60-70% (by weight) of Ulva Lactuca (“Ulva”), about 20-25% (by weight) of Sargassum, about 2-4% (by weight) of Ascophyllum nodosum (“Asco”), about 3-5% (by weight) of Fucus vesiculosis (“Fucus”), about 4-8% (by weight) of Gracilaria, about 0.5% (by weight) of Palmaria palmata, about 0.5% (by weight) of Ascophyllum nodosum high fucose extract powder, and about 0.1% (by weight), of a mixture of one or more of the following: Plocamium cartilagineum, Polysiphonia, Falkenbergia, Delleseria and Osmundia.

The following table sets out the content of an example formulation which has been specifically developed as a natural additive for swine feed,

| Ingredient | % (by weight) |
|---|---|
| Ulva | 64 |
| Sargassum | 22 |
| Asco | 3 |
| Fucus | 4 |
| Gracilaria | 6 |
| Palmaria | 0.5 |
| Asco high fucose extract powder | 0.5 |
| Plocamium, Polysiphonia, Falkenbergia, | 0.1 |
| Delleseria, Osmundia | |

In a most preferred embodiment the Additive preferably contains approximately 64% (by weight) of Ulva Lactuca (“Ulva”), about 22% (by weight) of Sargassum, about 3% (by weight) of Ascophyllum nodosum (“Asco”), about 4% (by weight) of Fucus vesiculosis (“Fucus”), about 6% (by weight) of Gracilaria, about 0.5% (by weight) of Palmaria palmata, about 0.5% (by weight) of Ascophyllum nodosum high fucose extract powder, and about 0.1% (by weight), of a mixture of one or more of the following: Plocamium cartilagineum, Polysiphonia, Falkenbergia, and Delleseria.

The high fucose powder from Asco which is added is the carbohydrate fraction containing fucose sugars, mannitol, laminarin and alginates, and is drum dried to obtain flakes, forming a product sold as dried natural polysaccharides or NDP. The methodology for extraction of the carbohydrate fraction from brown seaweeds is well known in the art. The composition of the high fucose powder is as follows, depending on seasonality and region where the seaweed is harvested:
ALGINIC ACID 20-30%
LAMINARAN 2-10%
FUCOIDAN 5-10%
MANNITOL 5-10%

Preferably the Additive is added to the regular feed in a proportion of from 0.5% to 5% by weight, and most preferably in a proportion of 0.5% by weight.

### EXAMPLE

Applicant carried out pigfarm feeding trials with its macroalgae mixture additive at different percentages of inclusion (0.5%, 2% and 5%) and compared the results against a reference diet. The standard feeds on the farm were used as the control diets. The additive was fed on top of the regular feed diet, diluting the other ingredients. Consequently there was slightly less (factor of 0.95) protein and oil present in the additive-included diet compared to the reference diet and slightly higher ash levels. During and at the end of the trial, test pigs were slaughtered and processed. At the kill floor intestinal samples were taken and meat samples were obtained after the pigs were processed and sent for taste analysis and packaging trials. After 4 months of trial from weaning stage to 100 kg pigs the results showed a positive outcome of having an Additive diet incorporated at 5% in the diet on taste and intestinal health. In respect of FCE and weight gain the lower inclusion level scored better than the control.

The experimental diets were compared with exactly the same diet without the additive. The starting weight immediately post weaning was ˜8.4 kg. The weaning period was 29 days. A total of 240 piglets were selected and randomly divided in to 40 piglets per pen. A total of 3 pens (120 piglets) were fed the reference feed (no additive) and 3 pens (120 piglets) were fed the test diet (additive fed over the top). The feeds provided in this trial do not use overly high nutrient densities in the feeds. The diet after weaning consisted of Granito (Milkiwean, Trouw) for 4 weeks together with Link (containing milk powder, maize and full-fat soya, as well as soya, wheat and barley). After week 5 a weaner feed was provided at the 25 kg stage followed by a grower feed at weight class 40-45 kg in week 8 after weaning till slaughter at week 15 after weaning at the 95-100 kg stage.

Data was gathered on live pigs on a weekly basis as follows:
Individual pig weights for first 6 weeks followed by batch after week 6
Visual assessment of apparent health and vitality
Mortalities and the reason for these
Feed Intake per pen
Weekly individual weights and, health/vitality assessment, mortalities and total feed per pen to be measured and recorded.

### Growth and FCE Analysis

Each week, the pigs were weighed together and individually and counted, to have the average weight and total biomass. Results were used to calculate the feeding amounts for the next week. The term feed conversion efficiency (FCE) is utilised to indicate the quantity of feed required to lay down a unit of body tissue. The term is used as indicators of the performance standard of a production system. The ability of the animal to convert food to tissue growth deteriorates with age. The suckling hog can convert at 0.9:1 whereas the older animal nearing sale weight will convert at 4:1. This deterioration in conversion is the combination of using cheaper feeds as the animal grows and the physiological changes within the animal. However, many factors have to be taken into consideration that affects FCE (e.g. health status, feed intake, environmental conditions, weight etc.). The food conversion efficiency also depends on the nutrient density of the diet. The higher the density of the diet, the tighter the FCE. The feeds provided in this trial did not use overly high nutrient densities in the feeds.

Feed conversion efficiency (FCE) is expressed as average feed intake per pig since weaning (AFI), divided by average daily gain since weaning (ADG) in kg/day:

FCE=AFI/ADG

### Growth Rate

The faster the growth the better the conversion efficiency. The animals with the highest lean meat deposition rates that achieve their potential growth rates will produce much better food conversion efficiencies throughout their life than underachievers with the same potential. Lean meat growth is very efficient; it requires much less energy than fat deposition. Hogs require each day a certain level of nutrient intake to survive. This requirement is called “maintenance” and it increases with body weight. The higher the hog's intake above its maintenance requirement the better the efficiency. If the animal only eats enough for maintenance then there is no growth. If the intake is below maintenance levels e.g. at weaning, then the animal will lose weight and if the intake is not increased will eventually die.

Growth rate is expressed as weight gain divided by time and expressed as follows:

G=(W2)−(W1)/t2−t1

Slaughter Protocol of Pigs from Trials

8 pigs were randomly selected from the trial groups of pigs (2 control and 6 treatment animals, Pigs c.80 kg Live weight) and again at full grow out weight of 100 kg. The pigs were spray marked and transported in an individual compartment from the farm to the slaughter plant. At the plant, the 8 pigs were penned together before slaughter and slaughtered together. During slaughter, the intestines of the pigs were retained for gut sampling. Normal measurement of lean percentage, fat, muscle depth took place (Carcass analysis). The Hennessey Grading Probe (HGP) and Fat-O-Meater (FOM) were used for pig carcass classification for the prediction of lean meat percentage in accordance with EU and UK legislation. Back fat thickness and muscle depth are measured using the Hennessey Grading Probe at a point 6 cm from the edge of the split back at the level of the ¾ last rib. Lean Meat percentage is then estimated according to the following formula:

Lean Meat %=60.30−0.847x1+0.147x2
where x1 and x2 represent back fat and muscle depths as measured by the Hennessy Grading Probe above.
Data gathered on slaughtered pigs was as follows:
   Gutted cold weight in kg
   Intestinal microbiology
   Intestinal morphology (sample and fix in formalin then section and H&E stain)
   Butcher's assessment of flesh quality and yield
   Label and freeze butchered cuts
   Taste/texture/appearance evaluation of selected cuts

### Intestinal Microbiology and Gut Morphology

To analyse the effect of addition of the additive on the gut flora a microbiological assessment was made. Gut samples were taken directly after the kill. Samples of each pig were taken about 50 cm after the pyloric valve in the duodenum and 50 cm before the cecum (illeocecum valve) in the ileum. Gastric samples were obtained by cutting the gut at the indicated places and squeezing the juices out into a plastic sample jar. Samples were immediately put on ice for microflora analysis. In order to detect any effects of the additive, an extended histological examination took place. Two sections as indicated above in the duodenum and ileaum from each intestine were taken directly after the kill and transferred to buffered Formalin and preserved. Sections (control and experimental) were stained by Haematoxylin & Eosin and examined for necrosis poor development or improved development of the microvilli.

### Producing Boneless Loin Chops for Taste Tests

When removing the meat from the carcass, the striploins (both from the left and right sides of each pig) were used for various taste and meat packaging/shelflife tests. Striploins were taken from both the control group of pigs as well as the supplemented pigs and clearly labeled. The meat was not allowed to be frozen as freezing denatures pigment systems. Sensory and consumer evaluation of pork samples fed conventional and seaweed supplemented feeds were done as follows: A sensory panel of 16 regular consumers of pork products was employed with consumer focus to evaluate pork chops. Chops cut from striploins were randomly selected, cooked, and presented to the panel for evaluation. Comments and scores were assessed together with texture and colour scores. The assessors were asked to evaluate the following descriptors: appearance, liking of flavour, juiciness, tenderness, oxidation flavour, off flavour and overall acceptability. For each piece of meat, assessors were asked to indicate their degree of liking on a scale ranging from 0 (extremely dislike) to 10 (extremely like). All samples were analyses in duplicate. Assessors were also asked to rank steaks according to their preference using the descriptors Unsatisfactory, Good, Very Good and Excellent every day eating quality.

### Shelf-Life Evaluation of Raw Pork Chops Held Under Overwrapped and Modified Atmosphere Packaging (MAP) Conditions

Shelf-life was assessed over 15 days (testing times; day 0, 3, 6, 9, 12, 15) using microbial evaluation (total counts and focus on certain pathogens). Furthermore instrumental colour, pH and lipid oxidation was measured. At the end of the trial which assessed meat quality, safety and sensory evaluation of fresh meat held under the two most common retail display pack formats, a report was prepared. When carrying out meat quality and storage trials, following the dietary supplementation with various nutraceuticals aimed at delivering antioxidant or antimicrobial properties, separate trials looked at the following:
Fresh meat storage trials looked at vacuum packaging for 6 weeks, modified atmosphere packaging (MAP) for 16 days and overwrapping for 10 days. The packaging system chosen and the time required for storage sets all three systems apart.
Frozen meat trials conducted under vacuum for 6 months
Cooked meat trials for MAP products for up to 6 weeks and vacuum packaged for about 3 months

The meat products were packaged as they would conventionally be packed and stored under retail conditions. In addition, the meat was stressed in different ways by the processing methods applied, and behaved differently, depending on the packaging systems used. Therefore, if the diet that the pigs have received provide some added advantage, it should emerge more clearly as the meat becomes more stressed when compared to the control pig group.

During the shelf-life trial, the following attributes were monitored;
Complete sensory evaluation by consumer panel evaluation
Colour analysis using sensory and instrumental approaches
Lipid oxidation as determined by sensory panels and by chemical means
Texture analysis as determined by sensory analysis and instrumental means
Microbiological stability
pH analysis over time
Drip loss assessment from fresh meat or cook-loss from cooked meat
Compositional changes
The above was conducted for whole meat (steak, chop etc) assessment and comminuted (patty, burger etc.) meat assessment to establish a difference in stability profile.

### Test Results

### General Observations

All pigs on the feed trials (control and treatment) performed excellently throughout. Additive inclusion levels at low percentages seemed to perform better than control and high percentages of Additive inclusion. The animals on an Additive diet were more alert and aware, looked brighter and had better skin development (no ulcerations or other skin problems) and a thick developed bristle coat contrary to some control pigs.

The trials with 240 pigs have shown the following:
1. Higher weight gain (pigs fed with 0.5% at harvest were 5.5 kg heavier on average and had a higher leaner meat percentage than control)
2. FCE lower at 0.5% inclusion on average 0.06 lower in Additive fed pig
3. Significantly improved taste and texture of the meat at 5% inclusion while having a marginal impact on FCE and growth. Tested and proven with independent taste panels.
4. Improved observed health and alertness of animals
5. Improved gut flora and morphology development
6. Improved environmental record due to no release of foreign synthetic matters in the feed. Seaweed is a marine product harvested from the Marine environment in a sustainable way. Especially in antibiotic use Additive improves environmental impact.

### Growth Performance and FCE

The addition of the Additive increased the ash (mineral) content of the diet which has a dilution effect on energy and amino acid density of the diet. This should have had a noticeable depressing effect on pig performance. Considering this, the pigs performed above expectations. The pigs on the Additive feed needed an adjustment period to be able to digest and use the new feed ingredients which is immediately expressed in a higher FCE for the pigs on the Additive in weeks 1 and 2. After adaptation of the digestive system the FCE's get much closer with an average difference of 0.06-0.08 in favour of control pigs. However, it should be noted that the Additive diet has a lower protein and oil content due to the dilution factor of over the top feeding. Differences in pigs in the beginning of the trial are due to explained mortalities (sow sitting on piglets). At the end of the trial 6 Additive-fed pigs were removed for slaughter and only 2 of the control. If one compares the daily gain and FCE with industry standards for the 40-60 kg class it is clear that the control and Additive diet do much better with differences of 0.5 to 0.6 in FCE in favour of the control and Additive diet.

The weight gain after the pigs were moved for finishing showed a final average weight of 92.8 kg for the control and 90.8 for the Additive fed pig after 105 days. Comparing the average daily gain in the 80-100 kg stage then the control as well as the Additive diet are above Industry standards of 885 g for male and 750 g for female with 120-250 g differences. It is known that at the finisher stage the pigs would have a feed intake of about 1750 to 1900 grams per day. Using these figures and the measured weight gain the calculated FCE was around 1.85 at the 90 kg stage. The results showed that for pure growth performance and other KPI's that 2% addition is the maximum tolerance for addition without having an effect on the FCE and growth. The 0.5% addition of Additive performed better in respect of FCE and KPI's compared to the standard diet.

### Carcass Analysis

Results showed that pigs fed the Additive diet had 1.2% more lean meat and were 5.5 kg heavier at slaughter. Using the grading scale, Additive-fed pigs had one carcass over 60% lean meat while the control had one carcass under 55% lean meat. All other carcasses fell in the E category (55-60% lean meat).

### Intestinal Development and Micro Flora

Taking gut flora samples at the factory it was very obvious which pigs were Additive-fed pigs and which were the controls by simply checking the colour of the intestines. Additive-fed pigs had greenish intestines while control had yellowish intestines.

The data from the gut flora analysis showed a 4 to 5 fold decrease in yeasts, lactic bacteria and pseudomonas species in the Additive fed pigs compared to the control pigs, most probably to do with the difference in diet. Pseudomonas is linked with numerous infections pending on the species such as P. aeruginosa and are hard to treat as many are resistant to antibiotics. The lower the count the better as is the case in the Additive fed pigs. More serious could be the presence of Listeria monocytogenus in the control pig sample. Listeria monocytogenes, a facultative anaerobe, intracellular bacterium, is the causative agent of listeriosis. It is one of the most virulent foodborne pathogens, with 20 to 30 percent of clinical infections resulting in death. Responsible for approximately 2,500 illnesses and 500 deaths in the United States (U.S.) annually, listeriosis is the leading cause of death among foodborne bacterial pathogens, with fatality rates exceeding even Salmonella and Clostridium botulinum.

### Taste Testing Results

Seaweed samples and control samples performed very similarly with respect to the sensory descriptors for Appearance and Juiciness. Both samples scored very low for Oxidation Flavour and Off-flavour indicating that there are no flavour taints in the samples. Assessors on average preferred the seaweed samples over the control sample for Liking of Flavour, however the control sample scored higher for Tenderness. This might be an effect of the leaner meat on seaweed fed pigs compared to the control. Controls had a lot of fat tissue. This agrees with the average values of the grading of the carcasses under the EU ranking system.

All sensory descriptors did not produce any significant differences between samples except, the seaweed sample, which scored significantly higher for Overall Acceptability by assessors compared to the control. Two consumers considered the seaweed samples and the control samples Unsatisfactory with respect to every day eating quality. Nine consumers considered the seaweed and fourteen consumers considered the control samples Good with respect to every day eating quality. Sixteen consumers considered seaweed samples and twelve consumers considered the control samples Very Good with respect to every day eating quality. Finally five consumers considered the seaweed samples and four consumers considered the control Excellent with respect to every day eating quality.

Both samples performed well in the consumer study and with respect to overall eating quality. Oxidation flavours and off-flavours were very low in both samples, but off-flavour was less present in the seaweed sample. All sensory descriptors did not produce any significant differences between samples except, seaweed samples which scored significantly higher for Overall Acceptability by assessors compared to the control. The general comments from taste testing of the experimental diets compared to reference diet were:
Sweeter taste
More succulent
No drippage or fat leaking
Very lean, little fat

### Conclusions

Pigs fed an Additive diet at 0.5% inclusion fed over the top performed better in growth, weight gain and FCR compared to the reference diets. Additive-Swine added up to 5% in the diet had slightly negative effects in FCE and other KPI's however compared to literature values was still superior on growth and FCE. Nevertheless this was to be expected as no correction was made for the dilution factor of over the top feeding and the Additive diet was therefore lower in protein and fats.

Carcass analysis indicated that Additive fed pigs were leaner and heavier at slaughter. First the animal goes through an adaptation period of 2 weeks in which we see the growth rate and FCE influenced negatively, Followed by a catching up period and finishing at a phase were the animals are slightly heavier and leaner. The potential for the Additive would be even better if the 5% addition would truly replace for example the vitamin and mineral premix and that the diet would be corrected for protein and fat. At 0.5% inclusion one saw no negative effects, on the contrary, animals grow better and have a lower FCE on an Additive compared to the control. From the trials it seems that 2% is the maximum allowable input in respect of FCE and growth.

The results from the taste test panel indicates that there is an overall preference for the seaweed pork chops, having less off-smell and slight advantage in juiciness and flavor. The trials indicate improved texture and flavour enhancement of the pork from use of the Additive.

Therefore there are two different options for implementing the Additive in the diets of pigs.
1. To improve nutrient uptake by creating a better gut envirionment and hence faster growth at a lower FCE. This can be achieved at low level inclusions of 0.5% to 1%
2. To improve and enhance taste profile and create a new market product with a marketing edge using 5% of the Additive in the diet

However there seems a 4 to 5 fold decrease in yeasts, lactic bacteria and pseudomonas species in the Additive fed pigs compared to the control pigs. A decrease in Pseudomonas could be very beneficial to the pig. Also the absence of Listeria monocytogenus in the Additive-fed pig is an important observation as L. monocytogenus is linked with listeriosis and can potentially be deadly for humans.

### Advantages of 0.5% Additive in Swine Feed

i) Replacement of 50% of current use of organic acids used in feed. Manuronic and guluronic acids (alginates), fucoidan and Ulvan can replace this function. Current cost of acids is [symbol] 3.5/kg. The Additive costs [symbol] 1/kg. Therefore there are direct cost saving results with 50% replacement of 0.75 cents per kg.

ii) Stimulation of the Butyric acid fermentation in colon. Short chain fatty acids (SCFAs; acetic, propionic and butyric acid) are formed during bacterial fermentation of carbohydrates in the colon. The interest in SCFA production is related to an increasing body of knowledge of the physiological effects of these acids. SCFAs are important anions in the colonic lumen and serve locally as nutrients for the mucosa cells, stimulating mucosal proliferation and blood flow. Especially butyric acid has been emphasized. It is the main energy substrate for the colonocytes and has been suggested to play a role in the prevention and treatment of diseases of the colonic mucosa, such as distal ulcerative colitis and cancer. Replacement of carbohydrate sources like wood pulp or other cellulose resources. Insoluble fibre like alginates in the Additive form a probiotic substrate and aid in the butyric and propionic acid fermentation. This will create a healthy gut environment stimulating e.g., lactic acid bacteria and inhibiting growth of e.g., Salmonella and E. coli.

iii) 50% reduction of antibiotics at farm level (drinking water and feed). The Additive with antibacterial and anti-viral substances like fucoidan, carrageenans but also di-terpenes and certain halogenated phenolic compounds acts as antibiotic. 50% cost saving.

iv) No Streptococcus suis treatment necessary. The Additive replaces routine use of antibiotic treatment against Streptococcus.

v) Faster weight gain (due to better gut environment and hence better nutrient uptake). The Additive incorporation has shown a faster weight gain and less days to get the animals to slaughter weight. Improves equal weight increase throughout the population and fewer days to get to slaughter weight. More pigs with higher weight on lower fat levels command a better price.

vi) Less back fat and better fat distribution creating leaner pigs. Better carcass quality (leaner meat) and higher price.

vii) Replacement of certain targeted minerals and trace elements. The Additive with its matric values can for example replace specific elements like calcium and potassium copper and vitamin C. Direct replacement of minerals and trace elements.

The Additive is an organic sustainable product which can provide a neutral carbon footprint. Seaweeds take up Nitrogen and Potassium from the ocean. Too much N and P causes eutrophication (often caused by agricultural run-off). Using seaweeds will help to generate a positive C, N and P balance for the farmer and possibly green credentials, sustainable production and carbon and nitrogen credits.

### Seaweed Characteristics

Seaweeds used in some example formulations also contain lipids and fatty acids. Red and brown seaweeds used in some example formulations are rich in 20-carbon atom polyunsaturated fatty acids (C20-PUFAs), chiefly eicosapentaenoic acid (EPA, ω 30-C20:5) and docosahexanoic acid (DHA), which are typically found in animals. Seaweeds are capable of metabolising various C20-PUFAs via oxidative pathways. In many red algae, the metabolised products of PUFAs, called oxylipins, resemble eicosanoid hormones in higher plants and humans which fulfill a range of physiologically important functions. Red and brown algae used in some example formulations also contain arachidonic acid (AA, ω 6-C20:4), and 18-carbon polyunsaturated fatty acids (linolenic or linoleic). Brown seaweeds typically have a higher linolenic acid concentration than red seaweeds. Green algae used in some example formulations show useful levels of alpha linolenic acid (ω 3-C18:3). Certain combinations of fatty acids have a strong immunological effect and can help fish to deter sea lice from attaching to the fish skin. Sea lice are a major concern in salmon farming and have a negative impact on growth and survival of fish.

Seaweeds used in some example formulations also contain relatively large amounts of polysaccharides. For example, some seaweeds used in example formulations contain cell wall structural polysaccharides such as alginates from brown seaweeds and agars and carrageenans from red seaweeds. Other polysaccharides contained in seaweeds used in some example formulations include fucoidans (from brown seaweeds), xylans (from certain red and green seaweeds), and ulvans in green seaweeds. Fucoidan is known to have a positive effect on skin and may help to combat sea lice. Seaweeds used in some example formulations also contain storage polysaccharides such as, for example, laminarin (B-1,3-glucan) in brown seaweeds and floridean starch (like glucan) in red seaweeds. Seaweeds containing polysaccharides in the form of fucoidans are selected for use in some example formulations due to their desirable biological activities (e.g. anti-thrombotic, anti-coagulant, anti-cancer, anti-proliferative, anti-viral, and anti-complementary agent, anti-inflammatory).

Several sulphated macroalgal polysaccharides have cytotoxic properties. Fucoidans present in some example formulations are known to have anti-tumour, anti-cancer, anti-metastatic and fibrinolytic properties in mice. Seaweeds used in some example formulations contain laminaran. Enzymatic action on laminaran produces Translam, (1-3:1-6-β-D glucans), which has antitumour properties. Ulvan present in some example formulations has cytotoxicity or cytostaticity targeted to normal or cancerous colonic epithelial cells, which is of major importance in salmon farming also in respect of skin maintenance and deterring sea lice.

Seaweeds used in some example formulations also contain relatively large amounts of mineral elements, macro-elements and trace elements. The mineral fraction of some seaweeds accounts for up to 36% of dry matter. The following tables set out some typical mineral, vitamin, and other nutritional content of brown, red and green seaweeds used in some example formulations:

TABLE 1
Brown Seaweeds:

| Protein | 5-20% | |
|---|---|---|
| Fat | 2-4% | |
| Carbohydrates | 42-64% | |
| Mannitol | 4.2% | |
| Alginic acid | 26% | |
| Laminaran | 5-18% | |
| Fucoidan | 4-7% | |
| Vitamin A | 0.7-0.8 | ppm |
| Vitamin C | 500-1650 | ppm |
| B-Carotene | 35-80 | ppm |
| Vitamin B1 | 1-5 | ppm |
| Vitamin B2 | 5-10 | ppm |
| Vitamin B3 | 10-30 | ppm |
| Vitamin B6 | 0.1-0.5 | ppm |
| Vitamin B12 | 0.8-3 | ppb |
| Vitamin E | 260-450 | ppm |
| Vitamin H | 0.1-0.4 | ppm |
| Vitamin K3 | 10 | ppm |
| Calcium | 1-3% | |
| Iodine | 700-4500 | ppm |
| Iron | 101-176 | ppm |
| Magnesium | 0.5-0.9% | |
| Manganese | 10-15 | ppm |
| Sodium | 3-4% | |
| Zinc | 70-240 | ppm |

TABLE 2
Red seaweeds:

| Protein | 12-37% | |
|---|---|---|
| Fat | 0.7-3% | |
| Carbohydrates | 46-76% | |
| Carrageenan | 40-45% | |
| Vitamin C | 130-1110 | ppm |
| B-Carotene | 266-384 | ppm |
| Vitamin B1 | 3-7 | ppm |
| Vitamin B2 | 2-29 | ppm |
| Vitamin B3 | 2-98 | ppm |
| Vitamin B6 | 9-112 | ppm |
| Vitamin B12 | 6.6 ppb-20 ppm | |
| Vitamin E | 1.71 | ppm |
| Calcium | 2000-8000 | ppm |
| Iodine | 150-550 | ppm |
| Iron | 56-350 | ppm |
| Magnesium | 0.2-0.5% | |
| Manganese | 10-155 | ppm |
| Sodium | 0.8-3% | |
| Zinc | 3 | ppm |
| Phosphorus | 0.8% | |
| Sulphur | 0.45% | |
| Boron | 16 | ppm |
| Flourine | 200 | ppm |
| Molybdenum | 39 | ppm |
| Chromium | 13 | ppm |
| Copper | 10 | ppm |
| Aluminium | <5 | ppb |
| Nickel | 30 | ppm |
| Cobalt | 6 | ppm |
| Selenium | 1 | ppm |

TABLE 3
Green Seaweeds:

| Protein | 10-25% | |
|---|---|---|
| Fat | 0.5-1.7% | |
| Carbohydrates | 42-48% | |
| Magnesium | 2.8% | |
| Vitamin A | 4286 | I.U. |
| Vitamin C | 40-200 | ppm |
| Vitamin B3 | 98 | ppm |
| Vitamin B12 | 6 | ppm |
| Calcium | 7300-9400 | ppm |
| Iodine | 70-240 | ppm |
| Iron | 152-1370 | ppm |
| Manganese | 12-347 | ppm |

| | |
|---|---|
| Sodium | 1.1-8.4% |

Formulations according to some example embodiments have relatively high antioxidant levels. High antioxidant content prolongs the shelf life of final feed products which include formulations according to certain embodiments of the invention, since essential fatty acids will be protected from going rancid. Seaweeds used in some example formulations are rich in polyphenols, which act as antioxidants. The highest content of polyphenols are typically found in brown seaweeds, where phlorotanin ranges from 5-15% of the dried weight. Seaweeds used in some example formulations are also rich in other antioxidants such as, for example, carotenoids, (especially fucoxanthin, B-carotene, and violaxanthin in some embodiments), and flavonoids.

Carotenoids in some example formulations are powerful antioxidants. Recent studies have shown the correlation between a diet rich in carotenoids and a diminishing risk of cardio-vascular disease, cancers (B-carotene, lycopene), as well as opthalmological diseases (lutein, zeaxanthin). Brown seaweeds are particularly rich in carotenoids especially in fucoxanthin, B-carotene, violaxanthin. The main carotenoids present in red algae are B-carotene and A-carotene and their dihydroxylated derivatives: zeaxanthin and lutein. The main carotenoids present in green algae are B-carotene, lutein, violaxanthin, antheraxanthin, zeaxanthin and neoxanthin.

Cartenoids in some example formluations also provide pigmentation. Such cartenoids avoid the need for chemically-produced keto-cartenoid pigments.

Formulations according to some example embodiments also contain bromophenols. The simple bromophenols, 2- and 4-bromophenol (2-BP, 4-BP), 2,4- and 2,6-dibromophenol (2,4-DBP, 2,6-DBP), and 2,4,6-tribromophenol (2,4,6-TBP), have been identified as key natural flavor components of seafood.

Formulations according to some example embodiments also contain feeding stimulants. Maximum benefit from feeding can only be achieved if the food provided is ingested. Ingestion efficiency depends on the feeding behaviour of the animal to be fed. To maximize ingestion of feed materials, feed products presented should have the correct appearance (ie. size, shape and colour), texture (ie. hard, soft, moist, dry, rough or smooth), density (buoyancy) and attractiveness (ie. smell or taste) to elicit an optimal feeding response. The relative importance of these individual factors will depend on whether the animal species in question is mainly a visual feeder or a chemosensory feeder.

### EXAMPLES

Formulations according to some embodiments of the invention contain between about 60-70% (by weight) of Ulva Lactuca (“Ulva”). Ulva typically has the following nutritional content:

| Protein | 15-25% | |
|---|---|---|
| Fat | 0.6-1% | |
| Carbohydrates | 42-46% | |
| Vitamin A | 4286 | I.U. |
| Vitamin C | 100-200 | ppm |
| Vitamin B3 | 98 | ppm |
| Vitamin B12 | 6 | ppm |
| Calcium | 7300 | ppm |
| Iodine | 240 | ppm |
| Iron | 870-1370 | ppm |
| Magnesium | 2.8% | |
| Manganese | 347 | ppm |

| | |
|---|---|
| Sodium | 1.1% |
| Potassium | 0.7% |

The Vitamin C content of Ulva can be particularly beneficial in acting as a protective antioxidant, assisting the synthesis of connective tissue and neurotransmitters, regulation of iron metabolism and activating the intestinal absorption of iron, strengthening the immune defence system, controlling the formation of conjunctive tissue and the protidic matrix of bony tissue, and also in trapping free radicals and regenerates Vitamin E. Ulva has high levels of natural colorants and short chained polysaccharides which are useful for flesh coloring and improving gut health respectively.

The cell-wall polysaccharides of ulvales represent 38 to 54% of the dry algal matter.

Two major kinds have been identified: water soluble ulvan and insoluble cellulose-like material. Ulvans are highly charged sulphated polyelectrolytes composed mainly of rhamnose, uronic acid and xylose as main monomer sugars and containing a common constituting disaccharide, the aldobiuronic acid, (1-4)-β-D-glucuronic acid-(1-4)-α-L-rhamnose3-sulfate-(1-2,12,16,22)-Iduronic acid is also a constituent sugar. Other potential applications of ulvan oligomers and polymers are related to their biological properties. Recent studies have demonstrated that ulvans and their oligosaccharides were able to modify the adhesion and proliferation of normal and tumoral human colonic cells as well as the expression of transforming growth factors (TGF-α) and surface glycosyl markers related to cellular differentiation. Earlier work demonstrated strain specific anti-influenza activities of ulvan from Ulva lactuca and the use of rhamnan, rhamnose and oligomers from desulphated Monostroma ulvans has been patented for the treatment of gastric ulcers.

Formulations according to some embodiments of the invention contain between about 20-25% (by weight) of Sargassum. This species contains high levels of essential antioxidants improving shelf life of fish, and also adds high levels of alginates and fucoidan, which have anti-bacterial and antiviral properties, and being long chained polysaccharides improve gut health, reduce bad bacteria (entero bacteria and E. coli) and increases good bacteria thereby permitting better nutrient absorption and hence growth.

Formulations according to some embodiments of the invention contain between about 2-4% (by weight) of Ascophyllum nodosum (“Asco”). Brown seaweeds such as Asco typically contain higher levels of vitamin E than green and red seaweeds. Asco typically has between about 200 and 600 mg of tocopherols per kg of dry matter. Asco also contains alpha, beta and gamma tocopherol, while green and red algaes typically only contain the alpha tocopherol. Gamma and alpha tocopherols increase the production of nitric oxide and nitric oxide synthase activity (cNOS) and also play an important role in the prevention of cardio-vascular disease. Asco also contains high levels of fucoidans (about 10-15% dry weight) and laminaran. Fucoidan is a polysaccharide with anti-viral and antibacterial properties.

Formulations according to some embodiments of the invention contain between about 4-8% (by weight) of Gracilaria. This species contains high levels of bromophenolic compounds improving taste of the farmed marine animal and high levels of protein and hence of essential amino acids.

Formulations according to some embodiments of the invention contain about 0.5% (by weight) of Palmaria palmata. This species contains kainic acid and is a helmintic agent (anti intestinal worm).

Formulations according to some embodiments of the invention contain about 0.1% (by weight) of Plocamium cartilagineum. This species has high levels of mono-terpenoids. Formulations according to some embodiments of the invention contain between about 0.05-1.0% (by weight) of a combination of equal parts Polysiphonia, Falkenbergia, and Delleseria. These species have high levels of bromophenols which improve the taste of farmed fish or marine animals such as shrimp. Polysiphonia is a marine red algae of the family Rhodomelaceae, which are a rich source of bromophenols. This family contains a variety of bromophenols with a range of biological activities, including feeding deterrent, R-glucosidase inhibitory, and growth stimulatory effects. Polysiphonia lanosa contains lanosol, 2,3-dibromo-4,5-dihydroxybenzyl alcohol. Lanosol has been known as a highly toxic substance for bacteria and algae. The red alga Asparagopsis taxiformis and tetrasporophyte Falkenbergia rufulanosa contains at least 52 organobromine compounds. Falkenbergia contains the halogenated natural product previously named mixed-halogenated compound 1 (MHC-1) was isolated from the red seaweed Plocamium cartilagineum. A total of 1.9 mg of pure MHC-1 was obtained from 1 g air-dried seaweed. The structure of MHC-1 was established to be (1R,2S,4R,5R,10E)-2-bromo-1-bromomethyl-1,4-dichloro-5-(20-chloroethenyl)-5-methylcyclohexane.

While a number of exemplary aspects and embodiments have been discussed above, those of skill in the art will recognize certain modifications, permutations, additions and sub-combinations thereof.

1. An additive for use in feed for swine containing between about 25-70% (by weight) of Ulva Lactuca (“Ulva”), about 5-25% (by weight) of Sargassum, about 2-15% (by weight) of Ascophyllum nodosum (“Asco”), about 2-15% (by weight) of Fucus vesiculosis (“Fucus”), about 2-30% (by weight) of Gracilaria, about 0.5-10% (by weight) of Palmaria palmata, about 0.5-10% (by weight) of Ascophyllum nodosum high fucose extract powder, and about 0.1-5% (by weight), of a mixture of one or more of the following: Plocamium cartilagineum, Polysiphonia, Falkenbergia, Dellesena and Osmundia.

2-24. (canceled)
